(19) United States
(12) Patent Application Publication
(10) Pub. No.: US 2017/0123915 A1
(43) Pub. Date: May 4, 2017

(54) METHODS AND SYSTEMS FOR REPURPOSING SYSTEM-LEVEL OVER PROVISIONED SPACE INTO A TEMPORARY HOT SPARE

(71) Applicant: Nimble Storage, Inc., San Jose, CA (US)

(72) Inventors: Hiep Nguyen, San Jose, CA (US); Anil Nanduri, Sunnyvale, CA (US); Chunqi Han, Pleasanton, CA (US)

(21) Appl. No.: 14/926,909

(22) Filed: Oct. 29, 2015

(51) Int. Cl. G06F 11/10; G06F 3/06; G06F 11/14; G06F 11/20

(52) U.S. Cl. CPC G06F 11/1092; G06F 11/1072; G06F 11/2058; G06F 11/2069; G06F 3/065; G06F 3/0619; G06F 3/0688; G06F 3/0655; G06F 11/1451; G06F 2201/84

(57) ABSTRACT

Described herein are techniques for rebuilding the contents of a failed storage unit in a storage system having a plurality of storage units. Rather than rebuilding the contents on a dedicated spare which may be costly, the contents are rebuilt on system-level over provisioned (OP) space of the non-failed storage units. Such system-level OP space is ordinarily used to perform garbage collection, but in the event of a storage unit failure, a fraction of the system-level OP space is repurposed into a temporary hot spare for storing the rebuilt contents. Upon recovery of the failed storage unit, the storage space allocated to the temporary hot spare is returned to the system-level OP space.

### FIELD OF THE INVENTION

The present invention relates to methods and systems for repurposing a fraction of system-level over provisioned (OP) space into a temporary hot spare, and more particularly relates to repurposing a fraction of system-level OP space on solid-state drives (SSDs) into a temporary hot spare.

### BACKGROUND

A storage system with a plurality of storage units typically employs data redundancy techniques (e.g., RAID) to allow the recovery of data in the event one or more of the storage units fails. While data redundancy techniques address how to recover lost data, a remaining problem is where to store the recovered data. One possibility is to wait until the failed storage unit has been replaced or repaired before storing the recovered data on the restored storage unit. However, in the time before the failed storage unit has been restored, the storage system experiences a degraded mode of operation (e.g., more operations are required to compute error-correction blocks; when data on the failed storage unit is requested, the data must first be rebuilt, etc.). Another possibility is to reserve one of the storage units as a hot spare, and store the recovered data onto the hot spare. While a dedicated hot spare minimizes the time in which the storage system experiences a degraded mode of operation, a hot spare increases the hardware cost of the storage system.

Techniques are provided below for storing recovered data (in the event of a storage unit failure) prior to the restoration of the failed drive and without using a dedicated hot spare.

### SUMMARY OF THE INVENTION

In accordance with one embodiment, lost data (i.e., data that is lost as a result of the failure of a storage unit) is recovered (or rebuilt) on system-level over provisioned (OP) space, rather than on a dedicated hot spare. The storage space of a storage unit (e.g., an SSD) typically includes an advertised space (i.e., space that is part of the advertised capacity of the storage unit) and a device-level OP space (i.e., space that is reserved to perform maintenance tasks such as device-level garbage collection). The system-level OP space may be formed on a portion of the advertised space on each of a plurality of storage units and is typically used for system-level garbage collection. The system-level OP space may increase the system-level garbage collection efficiency, which reduces the system-level write amplification. If there is a portion of the system-level OP space not being used by the system-level garbage collection, such portion of the system-level OP space can be used by the device-level garbage collection. Hence, the system-level OP space may also increase the device-level garbage collection efficiency, which reduces the device-level write amplification.

Upon the failure of a storage unit, a portion of the system-level OP space may be repurposed as a temporary hot spare, trading off system-level garbage collection efficiency (and possibly device-level garbage collection efficiency) for a shortened degraded mode of operation (as compared to waiting for the repair and/or replacement of the failed drive). The recovered or rebuilt data may be saved on the temporary hot spare (avoiding the need for a dedicated hot spare). After the failed storage unit has been repaired and/or replaced, the rebuilt data may be copied from the temporary hot spare onto the restored storage unit, and the storage space allocated to the temporary hot spare may be returned to the system-level OP space.

In accordance with one embodiment, a method is provided for a storage system having a plurality of solid-state drives (SSDs). Each of the SSDs may have an advertised space and a device-level OP space. For each of the SSDs, a controller of the storage system may designate a portion of the advertised space as a system-level OP space, thereby forming a collection of system-level OP spaces. In response to the failure of one of the SSDs, the storage system controller may repurpose a portion of the collection of system-level OP spaces into a temporary spare drive, rebuild data of the failed SSD, and store the rebuilt data onto the temporary spare drive. The temporary spare drive may be distributed across the SSDs that have not failed.

These and other embodiments of the invention are more fully described in association with the drawings below.

### BRIEF DESCRIPTION OF THE DRAWINGS

FIG. 1 depicts a storage system with a plurality of storage units, in accordance with one embodiment.

FIG. 2 depicts a storage system with a plurality of storage units, each having an advertised storage space and a device-level over provisioned (OP) space, in accordance with one embodiment.

FIG. 3 depicts a storage system with a plurality of storage units, each having an advertised storage space, a system-level OP space and a device-level OP space, in accordance with one embodiment.

FIG. 4 depicts a storage system with a plurality of storage units, with a portion of the system-level OP space repurposed into a temporary hot spare, in accordance with one embodiment.

FIG. 5 depicts a flow diagram of a process for repurposing system-level OP space into a temporary hot spare and using the temporary hot spare to store rebuilt data (i.e., data of a failed drive rebuilt using data and error-correction blocks from non-failed drives), in accordance with one embodiment.

FIG. 6 depicts an arrangement of data blocks, error-correction blocks and OP blocks in a storage system having a plurality of storage units, in accordance with one embodiment.

FIG. 7 depicts an arrangement of data blocks, error-correction blocks and OP blocks, after a first one of the storage units has failed, in accordance with one embodiment.

FIG. 8 depicts an arrangement of data blocks, error-correction blocks, OP blocks and spare blocks, after OP blocks have been repurposed into a first temporary spare drive, in accordance with one embodiment.

FIG. 9 depicts an arrangement of data blocks, error-correction blocks and OP blocks, after blocks of the first failed storage unit have been rebuilt and saved in the first temporary spare drive, in accordance with one embodiment.

FIG. 10 depicts an arrangement of data blocks, error-correction blocks and OP blocks, after a second storage unit has failed, in accordance with one embodiment.

FIG. 11 depicts an arrangement of data blocks, error-correction blocks and spare blocks, after additional OP blocks have been converted into a second temporary spare drive, in accordance with one embodiment.

FIG. 12 depicts an arrangement of data blocks and error-correction blocks, after blocks of the second failed storage unit have been rebuilt and saved in the second temporary spare drive, in accordance with one embodiment.

FIG. 13 depicts an arrangement of data blocks, error-correction blocks and OP blocks, after the rebuilt blocks of the first storage unit have been copied from the first temporary spare drive onto the restored first storage unit, in accordance with one embodiment.

FIG. 14 depicts an arrangement of data blocks, error-correction blocks and OP blocks, after the first temporary spare drive has been converted back into OP blocks, in accordance with one embodiment.

FIG. 15 depicts an arrangement of data blocks, error-correction blocks and OP blocks, after the rebuilt blocks of the second storage unit have been copied from the second temporary spare drive onto the restored second storage unit, in accordance with one embodiment.

FIG. 16 depicts an arrangement of data blocks, error-correction blocks and OP blocks, after the second temporary spare drive has been converted back into OP blocks, in accordance with one embodiment.

FIG. 17 depicts components of a computer system in which computer readable instructions instantiating the methods of the present invention may be stored and executed.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. Description associated with any one of the figures may be applied to a different figure containing like or similar components/steps. While the flow diagrams each present a series of steps in a certain order, the order of the steps may be changed.

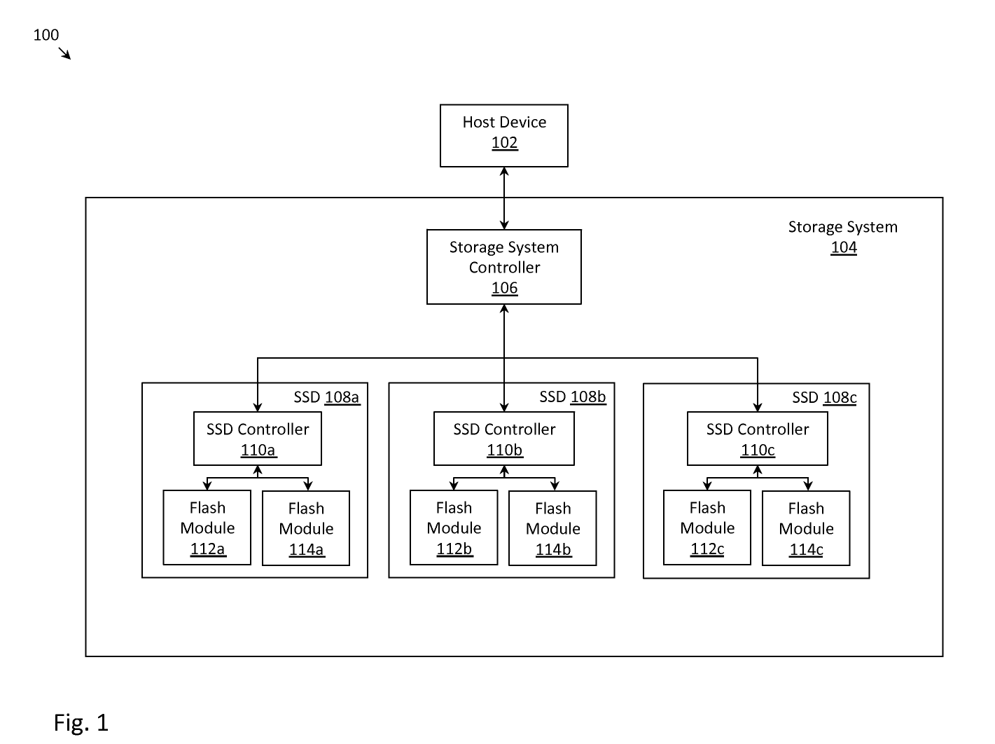

FIG. 1 depicts system 100 with host device 102 communicatively coupled to storage system 104. Host device 102 may transmit read and/or write requests to storage system 104, which in turn may process the read and/or write requests. While not depicted, storage system 104 may be communicatively coupled to host device 102 via a network. The network may include a LAN, WAN, MAN, wired or wireless network, private or public network, etc.

Storage system 104 may comprise storage system controller 106 and a plurality of storage units 108a-108c. While three storage units 108a-108c are depicted, a greater or fewer number of storage units may be present. In a preferred embodiment, each of the storage units is a solid-state drive (SSD). Storage system controller 106 may include a processor and memory (not depicted). The memory may store computer readable instructions, which when executed by the processor, cause the processor to perform data redundancy and/or recovery operations on storage system 104 (described below). Storage system controller 106 may also act as an intermediary agent between host device 102 and each of the storage units 108a-108c, such that requests of host device are forwarded to the proper storage unit(s), and data retrieved from the storage unit(s) is organized in a logical manner (e.g., data blocks are assembled into a data stripe) before being returned to host device 102.

Each of the storage units may include an SSD controller (which is separate from storage system controller 106) and a plurality of flash modules. For example, storage unit 108a may include SSD controller 110a, and two flash modules 112a, 114a. Storage unit 108b may include SSD controller 110b, and two flash modules 112b, 114b. Similarly, storage unit 108c may include SSD controller 110c, and two flash modules 112c, 114c. While each of the SSDs is shown with two flash modules for ease of illustration, it is understood that each SSD may contain many more flash modules. In one embodiment, a flash module may include one or more flash chips.

The SSD controller may perform flash management tasks, such as device-level garbage collection (e.g., garbage collection which involves copying blocks within one SSD). The SSD controller may also implement data redundancy across the flash modules within the SSD. For example, one of the flash modules could be dedicated for storing error-correction blocks, while the remaining flash modules could be dedicated for storing data blocks.

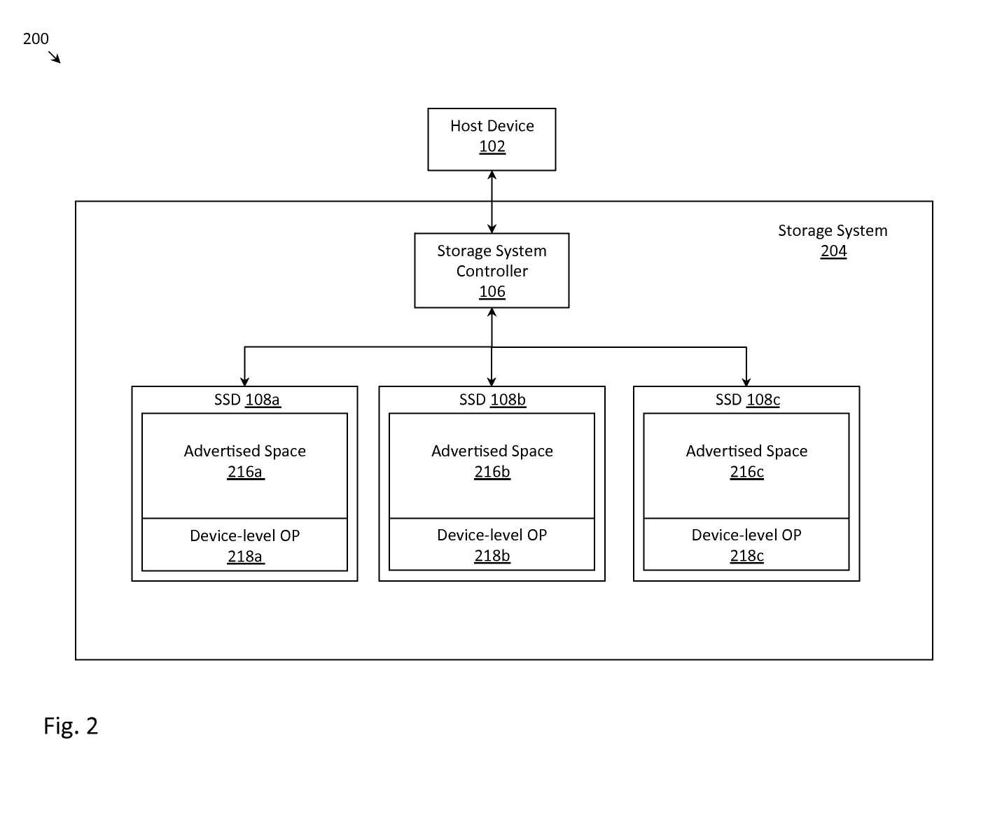

FIG. 2 depicts system 200 with host device 102 communicatively coupled to storage system 204. Storage system 204 may be identical to storage system 104, but a different aspect is being illustrated for the sake of discussion. In storage system 204, each of the SSDs is abstractly depicted with an advertised storage space and a device-level over provisioned (OP) space. For example, SSD 108a includes advertised storage space 216a and device-level OP space 218a. SSD 108b includes advertised storage space 216b and device-level OP space 218b. Similarly, SSD 108c includes advertised storage space 216c and device-level OP space 218c.

SSD controller 110a may access any storage space within SSD 108a (i.e., advertised space 216a and device-level OP space 218a). SSD controller 110b may access any storage space within SSD 108b (i.e., advertised space 216b and device-level OP space 218b). Similarly, SSD controller 110c may access any storage space within SSD 108c (i.e., advertised space 216c and device-level OP space 218c). In contrast to the SSD controllers, storage system controller 106 may access the advertised space across the SSDs (i.e., advertised space 216a, advertised space 216b and advertised space 216c), but may not have access to the device-level OP space (i.e., device-level OP space 218a, device-level OP space 218b and device-level OP space 218c). Similar to storage system controller 106, host device 102 may access (via storage system controller 106) the advertised space across the SSDs (i.e., advertised space 216a, advertised space 216b and advertised space 216c), but may not have access to the device-level OP space (i.e., device-level OP space 218a, device-level OP space 218b and device-level OP space 218c).

The OP percentage of an SSD is typically defined as the device-level OP storage capacity divided by the advertised storage capacity. For example, in an SSD with 80 GB advertised storage capacity and 20 GB device-level OP storage capacity, the device OP percentage would be 20 GB/80 GB or 25%. Continuing with this example, suppose that each of the SSDs in storage system 104 has 80 GB of advertised storage capacity and 20 GB of device-level OP storage capacity, the advertised storage capacity of storage system 104 would be 240 GB and the device-level OP percentage would be 60 GB/240 GB or 25%.

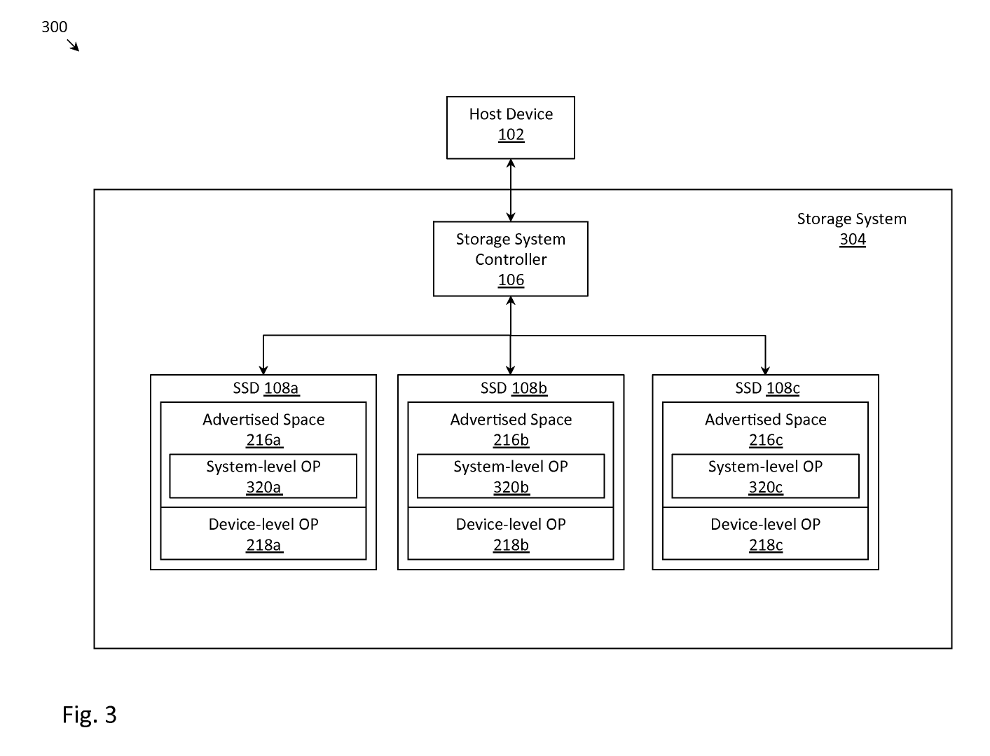

FIG. 3 depicts system 300 with host device 102 communicatively coupled to storage system 304, in accordance with one embodiment. In storage system 304, a portion of the advertised space may be designated as system-level OP space. For example, a portion of advertised space 216a may be designated as system-level OP space 320a. A portion of advertised space 216b may be designated as system-level OP space 320b. Similarly, a portion of advertised space 216c may be designated as system-level OP space 320c.

SSD controller 110a may access any storage space within SSD 108a (i.e., advertised space 316a, system-level OP space 320a and device-level OP space 218a). SSD controller 110b may access any storage space within SSD 108b (i.e., advertised space 316b, system-level OP space 320b and device-level OP 218b). Similarly, SSD controller 110c may access any storage space within SSD 108c (i.e., advertised space 316c, system-level OP space 320c and device-level OP space 218c). In contrast to the SSD controllers, storage system controller 106 may access the advertised space and system-level OP space across the SSDs (i.e., advertised space 316a, advertised space 316b, advertised space 316c, system-level OP space 320a, system-level OP space 320b and system-level OP space 320c), but may not have access to the device-level OP space (i.e., device-level OP space 218a, device-level OP space 218b and device-level OP space 218c). In contrast to storage system controller 106, host device 102 may access (via storage system controller 106) the advertised space across the SSDs (i.e., advertised space 316a, advertised space 316b and advertised space 316c), but may not have access to the system-level OP space across the SSDs (i.e., system-level OP space 320a, system-level OP space 320b and system-level OP space 320c) and the device-level OP space across the SSDs (i.e., device-level OP space 218a, device-level OP space 218b and device-level OP space 218c).

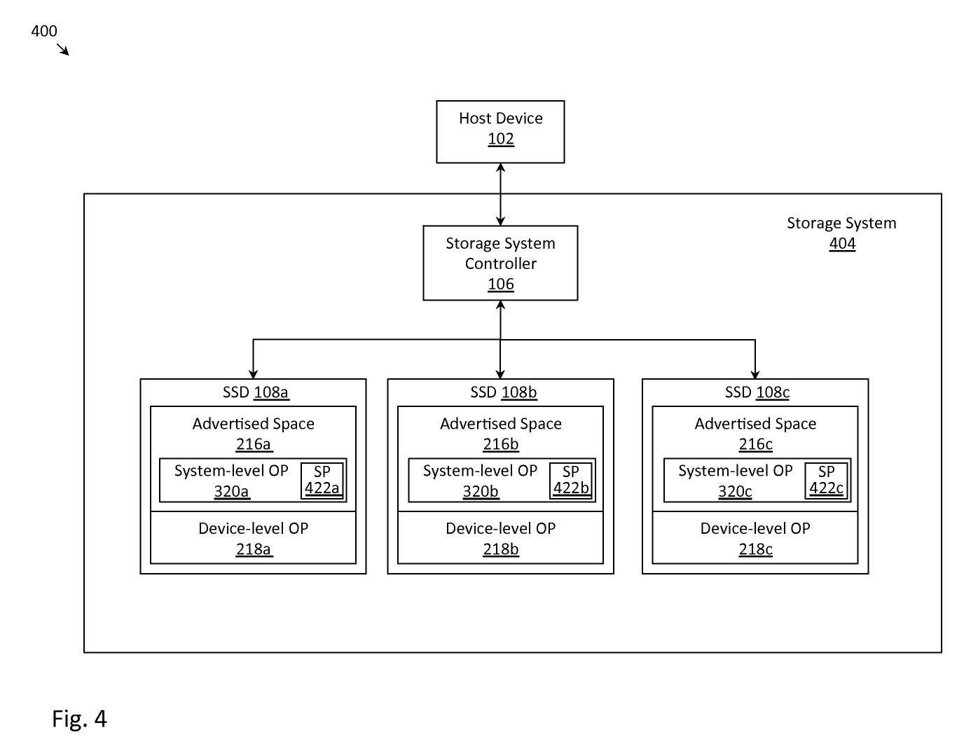

The system-level OP space may be used by storage system controller 106 to perform system-level garbage collection (e.g., garbage collection which involves copying blocks from one storage unit to another storage unit). The system-level OP space may increase the system-level garbage collection efficiency, which reduces the system-level write amplification. If there is a portion of the system-level OP space not being used by the system-level garbage collection, such portion of the system-level OP space can be used by the device-level garbage collection. Hence, the system-level OP space may also increase the device-level garbage collection efficiency, which reduces the device-level write amplification. However, in a failure mode (e.g., failure of one or more of the SSDs), a portion of the system-level OP space may be repurposed as a temporary hot spare drive (as shown in FIG. 4 below). The temporary reduction in the system-level OP space may decrease system-level (and device-level) garbage collection efficiency, but the benefits of the temporary hot spare drive for rebuilding data of the failed SSD(s) may outweigh the decreased system-level (and device-level) garbage collection efficiency.

FIG. 4 depicts system 400 with host device 102 communicatively coupled to storage system 404, in accordance with one embodiment. In storage system 404, a portion of the system-level OP space may be repurposed as one or more temporary hot spare drives. For example, a portion of system-level OP space 320a may be repurposed as temporary spare space (SP) 422a; a portion of system-level OP space 320b may be repurposed as temporary spare space (SP) 422b; and a portion of system-level OP space 320c may be repurposed as temporary spare space (SP) 422c. Temporary spare space 422a, temporary spare space 422b and temporary spare space 422c may collectively form one or more temporary spare drives which may be used to rebuild the data of one or more failed storage units. Upon recovery of the failed storage unit(s), the rebuilt data may be copied from the temporary spare drive(s) onto the recovered storage unit(s), and the temporary spare drive(s) may be converted back into system-level OP space (i.e., storage system 404 reverts to storage system 304).

In one embodiment, the amount of system-level OP space that is repurposed may be the number of failed SSDs multiplied by the advertised capacity (e.g., 216a, 216b, 216c) of each of the SSDs (assuming that all the SSDs have the same capacity). In another embodiment, the amount of system-level OP space that is repurposed may be the sum of each of the respective advertised capacities (e.g., 216a, 216b, 216c) of the failed SSDs. In another embodiment, the amount of system-level OP space that is repurposed may be equal to the amount of space needed to store all the rebuilt data. In yet another embodiment, system-level OP space may be re-purposed on the fly (i.e., in an as needed basis). For instance, a portion of the system-level OP space may be re-purposed to store one rebuilt data block, then another portion of the system-level OP space may be re-purposed to store another rebuilt data block, and so on.

As mentioned above, repurposing the system-level OP space may increase the system-level write amplification (and lower the efficiency of system-level garbage collection). Therefore, in some embodiments, there may be a limit on the maximum amount of system-level OP space that can be repurposed, and this limit may be dependent on the write amplification of the system-level garbage collection. If the system-level write amplification is high, the limit may be decreased (i.e., more system-level OP space can be reserved for garbage collection). If, however, the system-level write amplification is low, the limit may be increased (i.e., less system-level OP space can be reserved for garbage collection).

It is noted that in some instances, the capacity of the data that needs to be rebuilt may exceed the amount of system-level OP space that can be repurposed. In such cases, the data of some of the failed storage unit(s) may be rebuilt and stored on temporary spare drive(s), while other failed storage unit(s) may be forced to temporarily operate in a degraded mode.

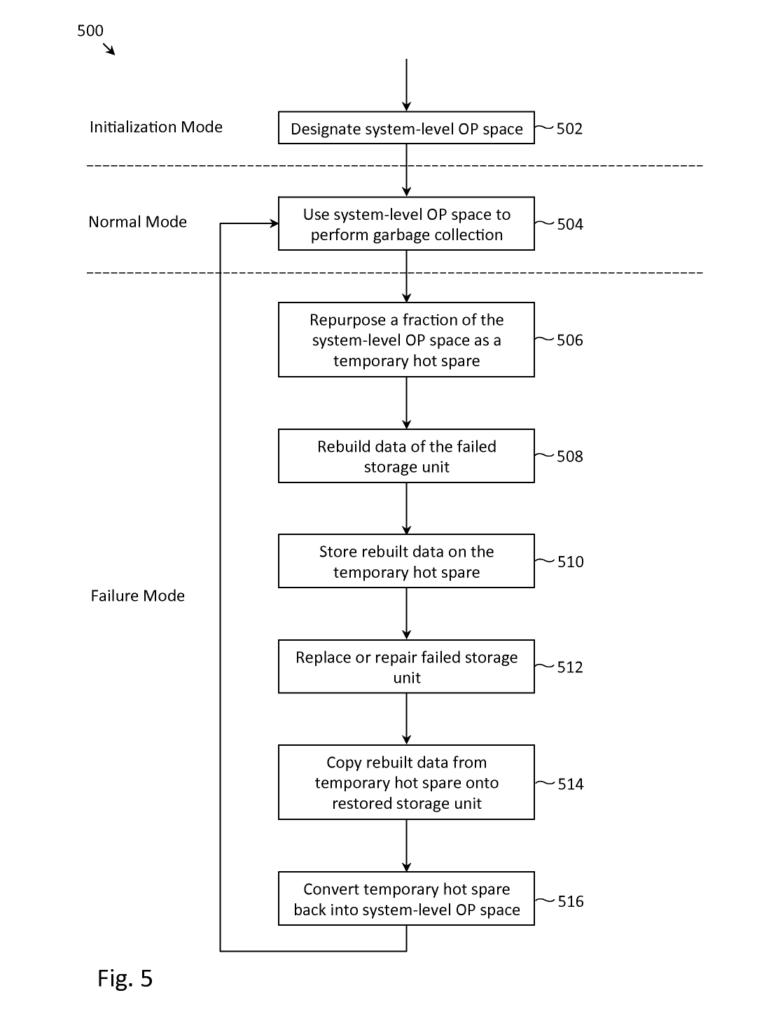

FIG. 5 depicts flow diagram 500 of a process for repurposing system-level OP space as a temporary hot spare and using the temporary hot spare to store rebuilt data (i.e., data of a failed storage unit rebuilt using data and error-correction blocks from non-failed drives), in accordance with one embodiment. In step 502, storage system controller 106 may designate a portion of the advertised space (i.e., advertised by a drive manufacturer) as a system-level OP space. Step 502 may be part of an initialization of storage system 204.

In step 504 (during a normal mode of operation of storage system 304), the system-level OP space may be used by storage system controller 106 to perform system-level garbage collection more efficiently (i.e., by reducing write amplification).

Subsequent to step 504 and prior to step 506, storage system 304 may enter a failure mode (e.g., one of the storage units may fail). At step 506, storage system controller 106 may repurpose a fraction of the system-level OP space as a temporary hot spare. At step 508, storage system controller 106 may rebuild data of the failed storage unit. At step 510, storage system controller 106 may store the rebuilt data on the temporary hot spare. At step 512, the failed storage unit may be restored, either by being replaced or by being repaired. At step 514, storage system controller 106 may copy the rebuilt data from the temporary hot spare onto the restored storage unit. At step 516, storage system controller 106 may convert the temporary hot spare drive back into system-level OP space. Storage system 304 may then resume a normal mode of operation, in which system-level OP space is used to more efficiently perform system-level garbage collection (step 504).

It is noted that the embodiment of FIG. 5 is a simplified process in that it only handles at most one failed storage unit at any moment in time. In another embodiment (not depicted), if a first storage unit has failed (and has not yet been restored) and a second storage unit fails, a separate procedure may be initiated to “heal” (i.e., restore storage capability of the storage unit and rebuild data on the storage unit) the second failed storage unit. This procedure (similar in nature to steps 506, 508, 510, 512, 514, 516) may be performed in parallel to the procedure (i.e., steps 506, 508, 510, 512, 514, 516) performed to heal the first failed storage unit. If the processing capabilities of storage system controller 106 are limited, the two procedures may be performed serially (i.e., heal the first storage unit before healing the second storage unit).

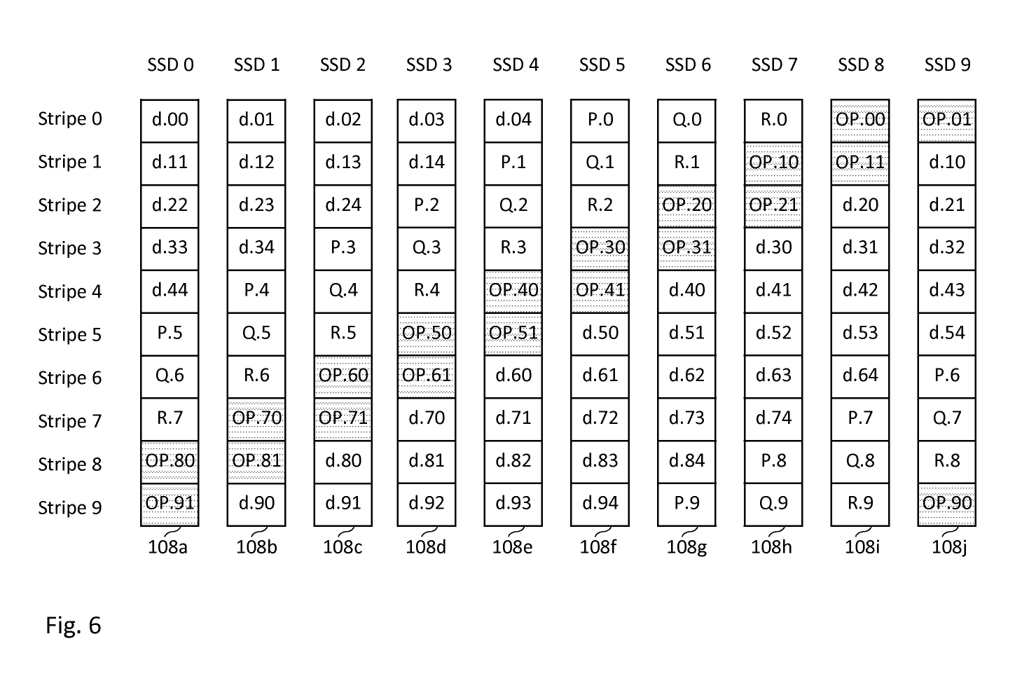

FIGS. 6-15 provide a detailed example in which two drives fail in close succession, and techniques of the present invention are employed to heal the failed drives. First, an overview is provided of a storage system with 10 storage units. It is understood that SSD 0 (labeled as 108a) may correspond to storage unit 108a in FIG. 4; SSD 1 (labeled as 108b) may correspond to storage unit 108b in FIG. 4; SSD 2 (labeled as 108c) may correspond to storage unit 108c in FIG. 4; SSD 3 (labeled as 108d) may correspond to another storage unit (not depicted) within storage system 404; and so on.

FIG. 6 depicts an arrangement of data blocks, error-correction blocks and system-level OP blocks on a plurality of storage units. The term “error-correction block(s)” will be used to generally refer to any block(s) of information that is dependent on one or more data blocks and can be used to recover one or more data blocks. An example of an error-correction block is a parity block, which is typically computed using XOR operations. It is noted that an XOR operation is only one operation that may be used to compute an error-correction block. More generally, an error-correction block may be computed based on a code, such as a Reed-Solomon code. The term “data block(s)” will be used to generally refer to any block(s) of information that might be transmitted to or from host device 102. The term “OP block(s)” will be used to generally refer to a portion or portions of system-level OP space (e.g., used to perform system-level garbage collection). The term “spare block(s)” (not present in FIG. 6, but present in subsequent figures) will be used to generally refer to a portion or portions of a temporary spare drive (e.g., used to store rebuilt blocks of a failed drive).

In the arrangement, error-correction blocks are labeled with reference labels that begin with the letter “P”, “Q” or “R”; data blocks are labeled with reference labels that begin with the letter “d”; OP blocks are labeled with reference labels that begin with the string “OP”; and spare blocks are labeled with reference labels that begin with the letter “S”.

Each row of error correction blocks and data blocks may belong to one data stripe (or “stripe” in short). For example, stripe 0 may include data blocks d.00, d.01, d.02, d.03 and d.04, and error correction blocks, P.0, Q.0 and R.0. If three or fewer of the blocks (i.e., data and error correction blocks) are lost, the remaining blocks in the data stripe (i.e., data and error correction blocks) may be used to rebuild the lost blocks. The specific techniques to rebuild blocks are known in the art and will not be described further herein. Since each stripe contains three parity blocks, the redundancy scheme is known as “triple parity”. While the example employs triple parity, it is understood that other levels of parity may be employed without departing from the spirit of the invention.

Certain blocks of the arrangement are illustrated with a horizontal line pattern. These blocks will be the primary focus of the operations described in the subsequent figures.

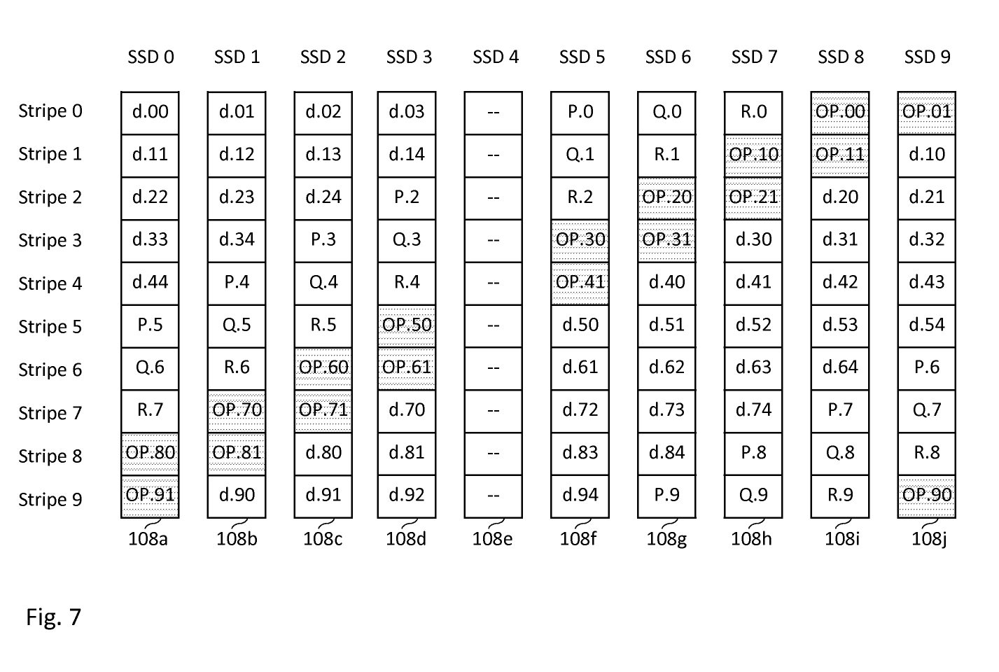

FIG. 7 depicts an arrangement of data blocks, error-correction blocks and OP blocks, after a first storage unit (i.e., SSD 4) has failed, in accordance with one embodiment. All the contents of SSD 4 are no longer accessible, and hence the contents of SSD 4 are represented as “--”. The storage system now operates with a dual-parity level of redundancy and runs in a degraded mode of operation.

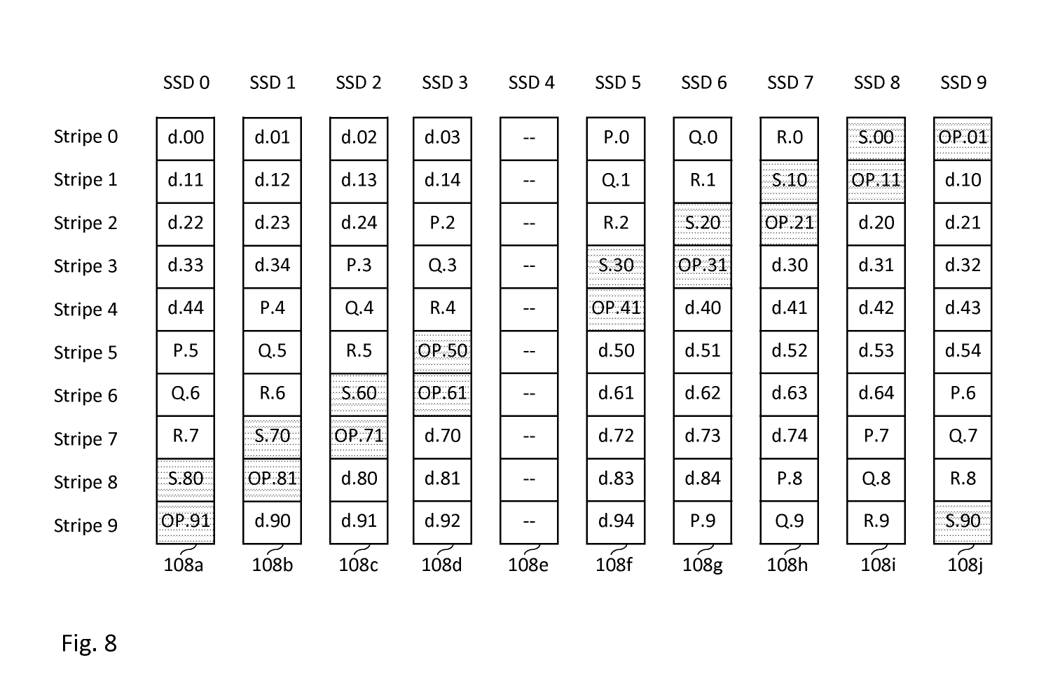

In response to the failure of SSD 4, OP blocks may be repurposed into a temporary spare drive so that the contents of the failed drive may be rebuilt on the spare drive. An arrangement of blocks after OP blocks have been repurposed into spare blocks is depicted in FIG. 8. More specifically, OP blocks OP.00, OP.10, OP.20, OP.30, OP.60, OP.70, OP.80 and OP.90 have been repurposed into spare blocks 5.00, S.10, S.20, S.30, S.60, S.70, S.80 and S.90, respectively. Spare blocks S.00, S.10, S.20, S.30, S.60, S.70, S.80 and S.90 collectively may form a first temporary spare drive.

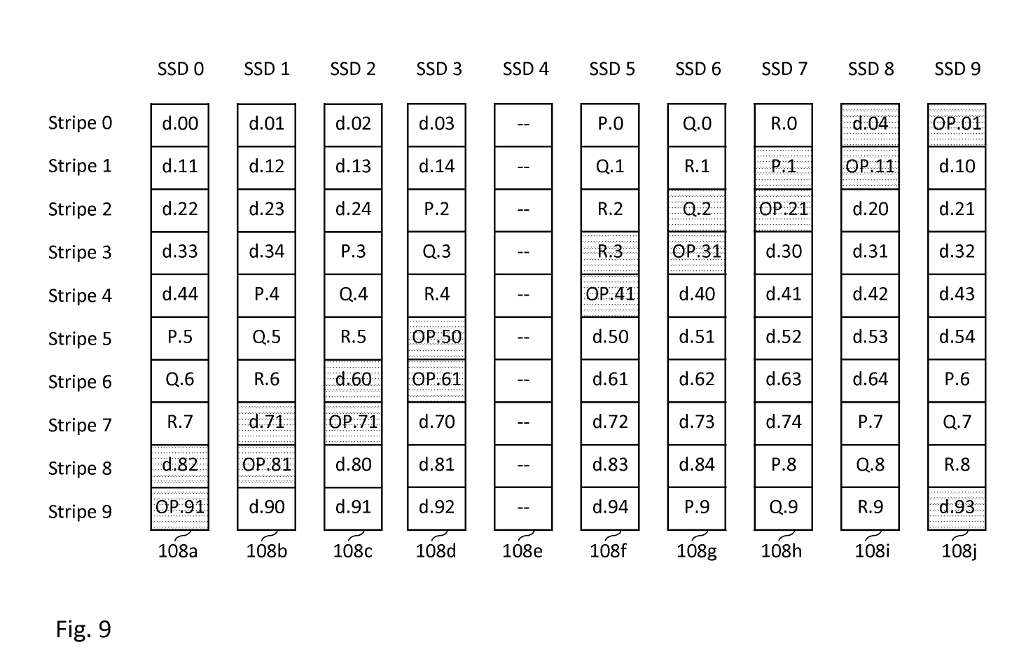

FIG. 9 depicts an arrangement of data blocks, error-correction blocks and OP blocks, after the contents of SSD 4 have been rebuilt and stored in the first temporary spare drive, in accordance with one embodiment. More specifically, blocks d.04, P.1, Q.2, R.3, d.60, d.71, d.82 and d.93 may be stored on spare blocks S.00, S.10, S.20, S.30, S.60, S.70, S.80 and S.90, respectively. After the contents of SSD 4 have been rebuilt and stored in the first temporary spare drive, the storage system recovers a triple-parity level of redundancy (and no longer operates in a degraded mode of operation). However, the amount of system-level OP space is reduced, so any system-level garbage collection performed by storage system controller 106 may be performed with reduced efficiency.

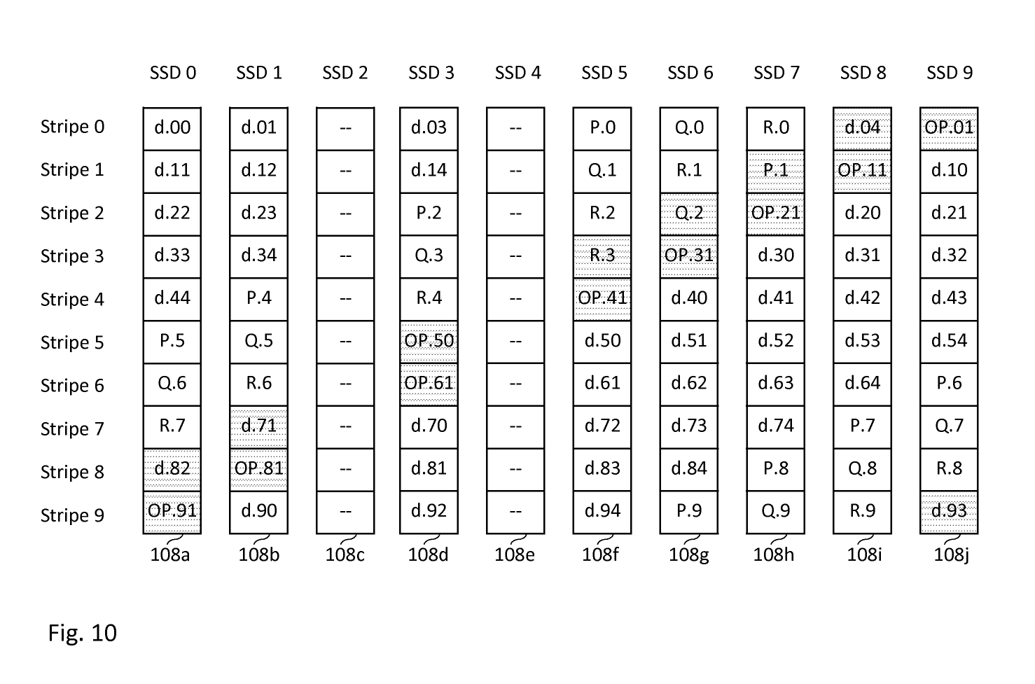

FIG. 10 depicts an arrangement of data blocks, error-correction blocks and OP blocks, after a second storage unit (i.e., SSD 2) has failed, in accordance with one embodiment. More particularly, SSD 2 has failed before SSD 4 has been restored, so there are two concurrent drive failures in the example of FIG. 10. The storage system once again operates with a dual-parity level of redundancy and runs in a degraded mode of operation.

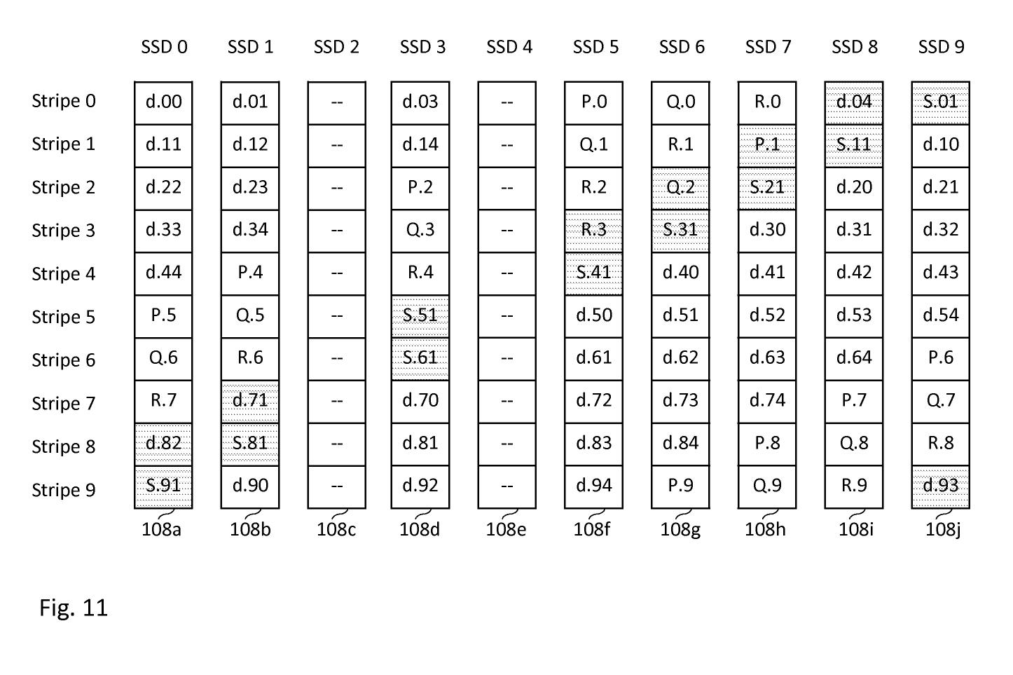

FIG. 11 depicts an arrangement of data blocks, error-correction blocks and spare blocks, after additional OP blocks have been converted into a second temporary spare drive, in accordance with one embodiment. More specifically, OP blocks OP.01, OP.11, OP.21, OP.31, OP.41, OP.50, OP.61, OP.81 and OP.91 may be repurposed into spare blocks S.01, S.11, S.21, S.31, S.41, S.51, S.61, S.81 and S.91, respectively. While the arrangement in FIG. 11 does not depict any remaining system-level OP blocks, this is for ease of illustration, and system-level OP blocks (not depicted) may still be present in the storage system. Therefore, while the amount of system-level OP space has further decreased (which reduces garbage collection efficiency), it is not necessarily the case that all system-level OP space has been converted into temporary spare drive(s). In general, it is preferred to always maintain a minimum quantity (or percentage) of system-level OP space so that the system-level garbage collection can still function properly, although with reduced efficiency.

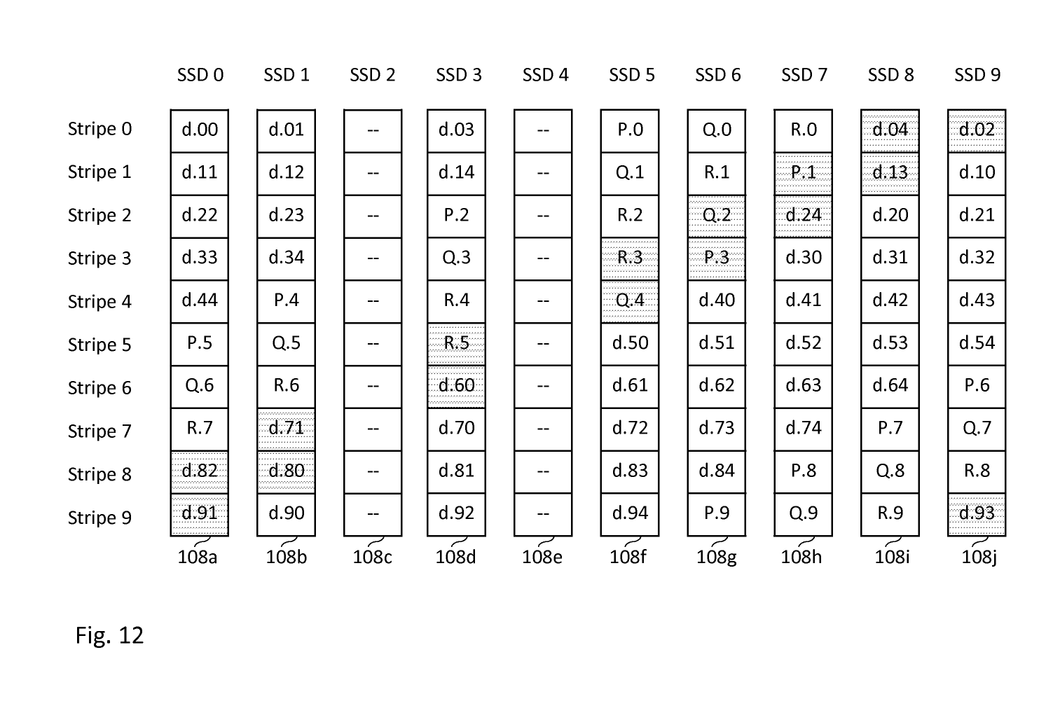

FIG. 12 depicts an arrangement of data blocks and error-correction blocks, after blocks of SSD 2 have been rebuilt and saved in the second temporary spare drive, in accordance with one embodiment. More specifically, blocks d.02, d.13, d.24, P.3, Q.4, R.5, d.60, d.80 and d.91 may be stored on spare blocks S.01, S.11, S.21, S.31, S.41, S.51, S.61, S.81 and S.91, respectively. After the contents of SSD 2 have been rebuilt and saved in the second temporary spare drive, the storage system once again recovers a triple-parity level of redundancy (and no longer operates in a degraded mode of operation). However, the amount of system-level OP space is further reduced, so any system-level garbage collection performed by storage system controller 106 may be performed with an even further reduced efficiency.

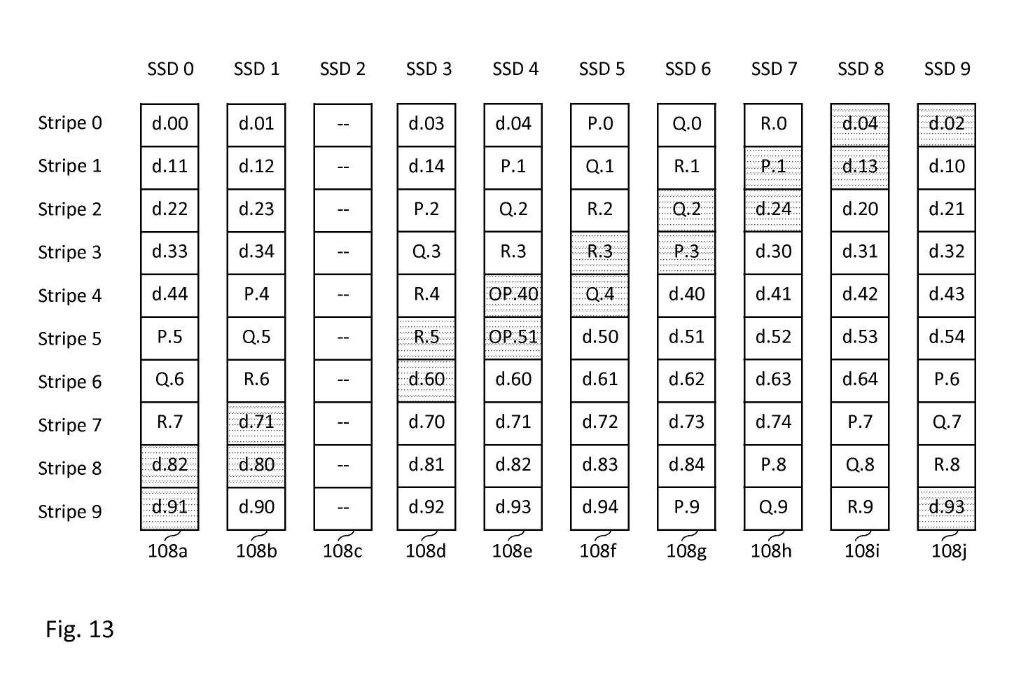

FIG. 13 depicts an arrangement of data blocks, error-correction blocks and OP blocks, after SSD 4 has been restored, and the rebuilt blocks of the SSD 4 have been copied from the first temporary spare drive onto the restored SSD 4, in accordance with one embodiment. It is noted that certain blocks of SSD 4 have been designated as OP blocks OP.40 and OP.51, as was the case before the failure of SSD 4.

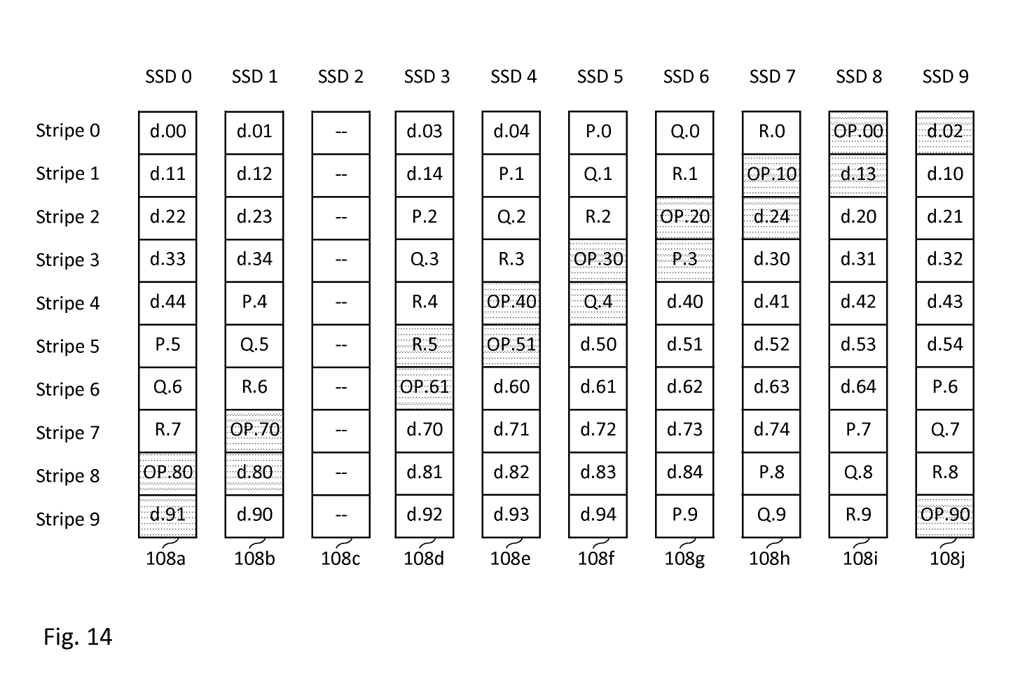

FIG. 14 depicts an arrangement of data blocks, error-correction blocks and OP blocks, after the first temporary spare drive has been converted back into OP blocks, in accordance with one embodiment. More specifically, blocks d.04, P.1, Q.2, R.3, d.60, d.71, d.82 and d.93 on the first temporary spare drive may be converted back into OP blocks OP.00, OP.10, OP.20, OP.30, OP.61, OP.70, OP.80 and OP.90, respectively.

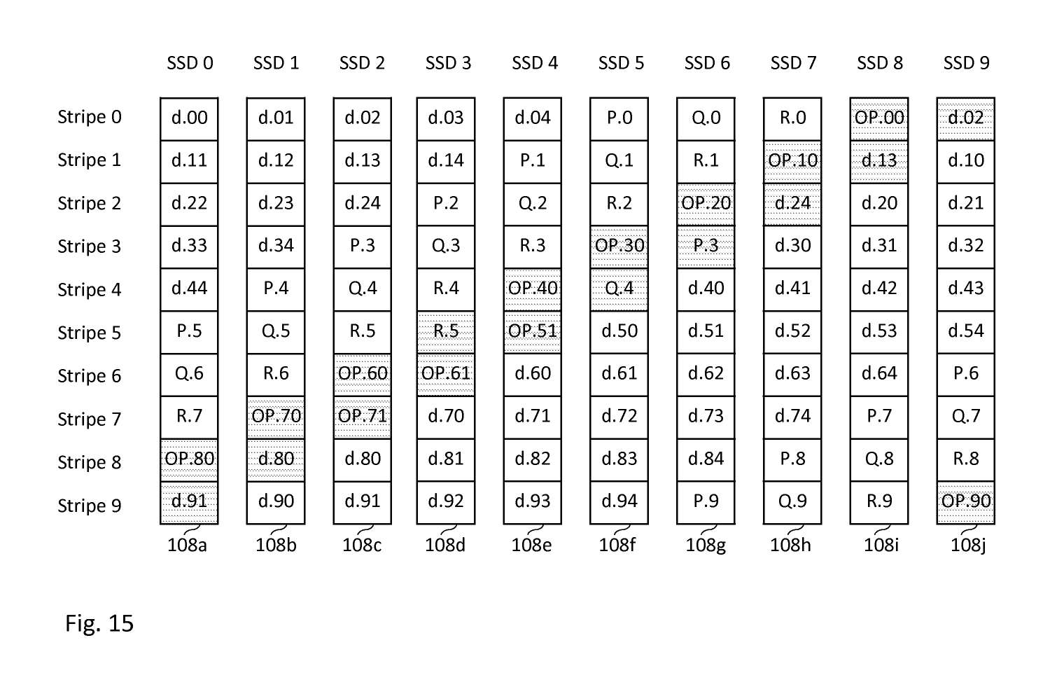

FIG. 15 depicts an arrangement of data blocks, error-correction blocks and OP blocks, after SSD 2 has been restored, and the rebuilt blocks of SSD 2 have been copied from the second temporary spare drive onto the restored SSD 2, in accordance with one embodiment.

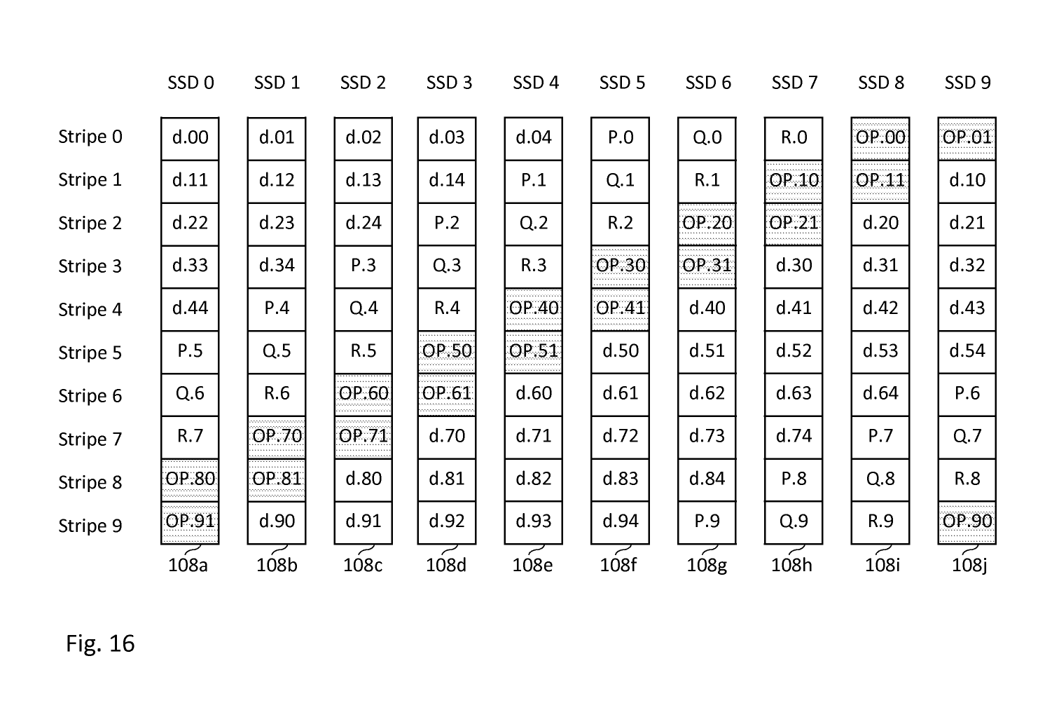

FIG. 16 depicts an arrangement of data blocks, error-correction blocks and OP blocks, after the second temporary spare drive has been converted back into OP blocks, in accordance with one embodiment. More specifically, blocks d.02, d.13, d.24, P.3, Q.4, R.5, d.80 and d.91 on the second temporary spare drive may be converted back into OP blocks OP.01, OP.11, OP.21, OP.31, OP.41, OP.50, OP.81 and OP.91, respectively. It is noted that FIG. 16 is identical to FIG. 6, so the contents of the storage system have been completely returned to their original state following the failure of SSDs 2 and 4. To summarize, an example has been provided in FIGS. 6-16 in which system-level OP space was repurposed into two temporary spare drives which were then used to store the rebuilt content of two failed SSDs.

In the example of FIGS. 6-16, the rebuilt contents of the failed SSDs were completely stored on the temporary spare drives before the failed SSDs were restored. In another scenario, it is possible that when the contents of the failed SSD(s) are being stored on the temporary spare drive(s), the failed SSD(s) are restored. If this happens, the rebuilt contents that have not yet been stored on the temporary spare drive(s) could be directly written onto the restored SSD(s) rather than on the temporary spare drive(s). Such technique would reduce the amount of data that would need to be copied from the temporary spare drive(s) to the restored SSD(s).

In the example of FIGS. 6-16, the rebuilt contents of SSD 4 were completely stored on the first temporary spare drive before SSD 2 failed. In another scenario, it is possible that SSD 2 fails while the contents of SSD 4 are being stored on the first temporary spare drive. If this happens, certain factors may be considered in determining when to start rebuilding the contents of SSD 2. For example, if the rebuild of SSD 4 has just started (e.g., is less than 20% complete), the rebuild of SSD 2 may start immediately, such that the contents of both SSDs may be rebuilt around the same time. Otherwise, if the rebuild of SSD 4 is already underway (e.g., is more than 20% complete), the rebuild of SSD 2 may start after the rebuild of SSD 4 has completed.

In the example of FIGS. 6-16, OP space from all the non-failed drives were used to store rebuilt data. In another embodiment, it is possible to repurpose OP space from a subset of the non-failed drives. For example, OP space non-failed drives with the lowest wear could be repurposed, as part of a wear-leveling strategy.

While the embodiments above have described re-purposing a fraction of the system-level OP space as a temporary hot spare, it is possible, in some embodiments, to re-purpose a fraction of the system-level OP space for other purposes, such as for logging data, caching data, storing a process core dump and storing a kernel crash dump. More generally, it is possible to re-purpose a fraction of the system-level OP space for any use case, as long as the use is for a short-lived “emergency” task that is higher in priority than garbage collection efficiency.

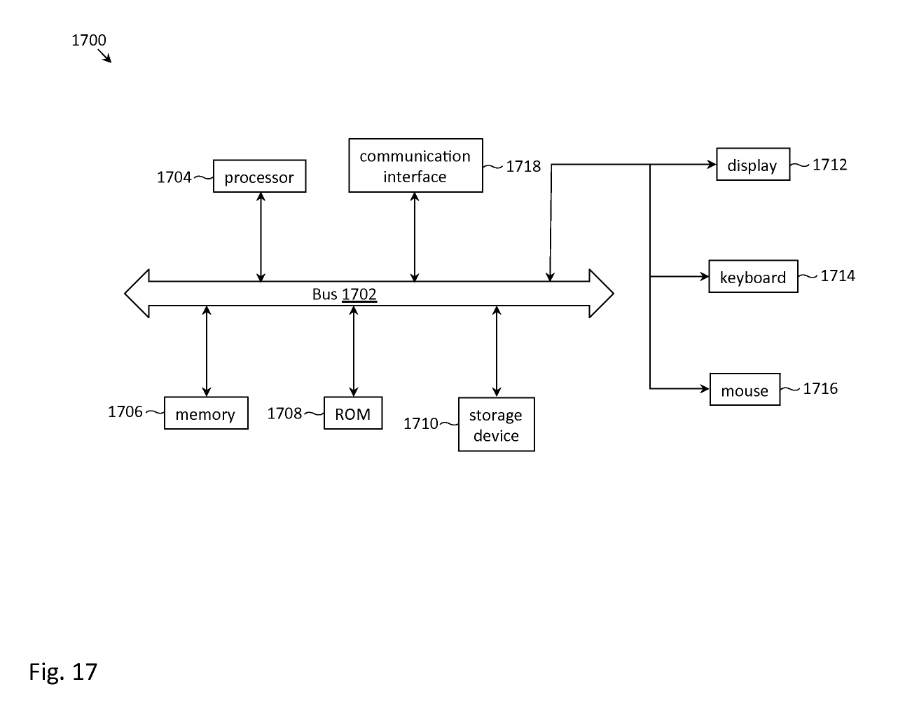

As is apparent from the foregoing discussion, aspects of the present invention involve the use of various computer systems and computer readable storage media having computer-readable instructions stored thereon. FIG. 17 provides an example of computer system 1700 that is representative of any of the storage systems discussed herein. Further, computer system 1700 may be representative of a device that performs the processes depicted in FIG. 5. Note, not all of the various computer systems may have all of the features of computer system 1700. For example, certain of the computer systems discussed above may not include a display inasmuch as the display function may be provided by a client computer communicatively coupled to the computer system or a display function may be unnecessary. Such details are not critical to the present invention.

Computer system 1700 includes a bus 1702 or other communication mechanism for communicating information, and a processor 1704 coupled with the bus 1702 for processing information. Computer system 1700 also includes a main memory 1706, such as a random access memory (RAM) or other dynamic storage device, coupled to the bus 1702 for storing information and instructions to be executed by processor 1704. Main memory 1706 also may be used for storing temporary variables or other intermediate information during execution of instructions to be executed by processor 1704. Computer system 1700 further includes a read only memory (ROM) 1708 or other static storage device coupled to the bus 1702 for storing static information and instructions for the processor 1704. A storage device 1710, which may be one or more of a floppy disk, a flexible disk, a hard disk, flash memory-based storage medium, magnetic tape or other magnetic storage medium, a compact disk (CD)-ROM, a digital versatile disk (DVD)-ROM, or other optical storage medium, or any other storage medium from which processor 1704 can read, is provided and coupled to the bus 1702 for storing information and instructions (e.g., operating systems, applications programs and the like).

Computer system 1700 may be coupled via the bus 1702 to a display 1712, such as a flat panel display, for displaying information to a computer user. An input device 1714, such as a keyboard including alphanumeric and other keys, is coupled to the bus 1702 for communicating information and command selections to the processor 1704. Another type of user input device is cursor control device 1716, such as a mouse, a trackball, or cursor direction keys for communicating direction information and command selections to processor 1704 and for controlling cursor movement on the display 1712. Other user interface devices, such as microphones, speakers, etc. are not shown in detail but may be involved with the receipt of user input and/or presentation of output.

The processes referred to herein may be implemented by processor 1704 executing appropriate sequences of computer-readable instructions contained in main memory 1706. Such instructions may be read into main memory 1706 from another computer-readable medium, such as storage device 1710, and execution of the sequences of instructions contained in the main memory 1706 causes the processor 1704 to perform the associated actions. In alternative embodiments, hard-wired circuitry or firmware-controlled processing units (e.g., field programmable gate arrays) may be used in place of or in combination with processor 704 and its associated computer software instructions to implement the invention. The computer-readable instructions may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, all of the aforementioned terms are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying” or the like, refer to the action and processes of an appropriately programmed computer system, such as computer system 700 or similar electronic computing device, that manipulates and transforms data represented as physical (electronic) quantities within its registers and memories into other data similarly represented as physical quantities within its memories or registers or other such information storage, transmission or display devices.

Computer system 1700 also includes a communication interface 1718 coupled to the bus 1702. Communication interface 1718 provides a two-way data communication channel with a computer network, which provides connectivity to and among the various computer systems discussed above. For example, communication interface 1718 may be a local area network (LAN) card to provide a data communication connection to a compatible LAN, which itself is communicatively coupled to the Internet through one or more Internet service provider networks. The precise details of such communication paths are not critical to the present invention. What is important is that computer system 1700 can send and receive messages and data through the communication interface 1718 and in that way communicate with hosts accessible via the Internet.

Thus, methods and systems for repurposing system-level OP space into temporary spare drive(s) have been described. It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method for a storage system having a plurality of solid-state drives (SSDs), each of the SSDs having an advertised space and a device-level over provisioned (OP) space, the method comprising:
for each of the SSDs, designating by a controller of the storage system a portion of the advertised space as a system-level OP space, thereby forming a collection of system-level OP spaces; and
in response to a failure of one of the SSDs, (i) repurposing a portion of the collection of system-level OP spaces into a temporary spare drive, (ii) rebuilding data of the failed SSD, and (iii) storing the rebuilt data onto the temporary spare drive, wherein the temporary spare drive is distributed across the SSDs that have not failed.

2. The method of claim 1, wherein the device-level OP space on each of the SSDs is not accessible to the storage system controller.

3. The method of claim 1, wherein the device-level OP space on each of the SSDs is accessible to a device-level controller located on the corresponding SSD.

4. The method of claim 1, wherein the device-level OP space on each of the SSDs is used to perform a device-level garbage collection.

5. The method of claim 1, wherein the system-level OP space on each of the SSDs is used to perform a system-level garbage collection.

6. The method of claim 5, wherein a limit on the maximum amount of the system-level OP space on each of the SSDs that is repurposed for the temporary hot spare is based on a write amplification of the system-level garbage collection.

7. The method of claim 1, further comprising:
upon restoration of the failed SSD, copying the rebuilt data from the temporary spare drive onto the restored SSD and returning space allocated to the temporary spare drive back to the collection of system-level OP spaces.

8. A storage system, comprising:
a plurality of solid-state drives (SSDs), each of the SSDs having an advertised space and a device-level over provisioned (OP) space; and
a storage system controller communicatively coupled to the plurality of SSDs, the storage system controller configured to:
for each of the SSDs, designate a portion of the advertised space as a system-level OP space, thereby forming a collection of system-level OP spaces; and
in response to a failure of one of the SSDs, (i) repurpose a portion of the collection of system-level OP spaces into a temporary spare drive, (ii) rebuild data of the failed SSD, and (iii) store the rebuilt data into the temporary spare drive, wherein the temporary spare drive is distributed across the SSDs that have not failed.

9. The storage system of claim 8, wherein the device-level OP space on each of the SSDs is not accessible to the storage system controller.

10. The storage system of claim 8, wherein the device-level OP space on each of the SSDs is accessible to a device-level controller located on the corresponding SSD.

11. The storage system of claim 8, wherein the device-level OP space on each of the SSDs is used to perform a device-level garbage collection.

12. The storage system of claim 8, wherein the system-level OP space on each of the SSDs is used to perform a system-level garbage collection.

13. The storage system of claim 8, wherein a limit on the maximum amount of the system-level OP space on each of the SSDs that is repurposed for the temporary hot spare is based on a write amplification of the system-level garbage collection.

14. The storage system of claim 8, wherein the storage system controller is further configured to, upon restoration of the failed SSD, copy the rebuilt data from the temporary spare drive onto the restored SSD and return space allocated to the temporary spare drive back to the collection of system-level OP spaces.

15. A non-transitory machine-readable storage medium for a storage system having a storage system controller and plurality of solid-state drives (SSDs), each of the SSDs having an advertised space and a device-level over provisioned (OP) space, the non-transitory machine-readable storage medium comprising software instructions that, when executed by a processor of the storage system controller, cause the processor to:
for each of the SSDs, designate a portion of the advertised space as a system-level OP space, thereby forming a collection of system-level OP spaces; and
in response to a failure of one of the SSDs, (i) repurpose a portion of the collection of system-level OP spaces into a temporary spare drive, (ii) rebuild data of the failed SSD, and (iii) store the rebuilt data into the temporary spare drive, wherein the temporary spare drive is distributed across the SSDs that have not failed.

16. The non-transitory machine-readable storage medium of claim 15, wherein the device-level OP space on each of the SSDs is not accessible to the storage system controller.

17. The non-transitory machine-readable storage medium of claim 15, wherein the device-level OP space on each of the SSDs is accessible to a device-level controller located on the corresponding SSD.

18. The non-transitory machine-readable storage medium of claim 15, wherein the system-level OP space on each of the SSDs is used to perform a system-level garbage collection.

19. The non-transitory machine-readable storage medium of claim 18, wherein a limit on the maximum amount of the system-level OP space on each of the SSDs that is repurposed for the temporary hot spare is based on a write amplification of the system-level garbage collection.

20. The non-transitory machine-readable storage medium of claim 15, further comprising software instructions that, when executed by the processor of the storage system controller, cause the processor to, upon restoration of the failed SSD, copy the rebuilt data from the temporary spare drive onto the restored SSD and return space allocated to the temporary spare drive back to the collection of system-level OP spaces.
